(19) United States
(12) Patent Application Publication
(10) Pub. No.: US 2005/0231960 A1
(43) Pub. Date: Oct. 20, 2005

(54) Detachable lampshade

(76) Inventor: Xinyu Li, Dongguan City (CN)

Correspondence Address: Mr. Eric Chan, 42 Pin Oaks Drive, Phoenixville, PA, 19460, US

(21) Appl. No.: 10/951,075

(22) Filed: Sep. 28, 2004

(30) Foreign Application Priority Data
Apr. 16, 2004 (CN) 200420044868.3
Jul. 21, 2004 (CN) 200420071734.0

(51) Int. Cl. F21V 1/06

(52) U.S. Cl. 362/352; 362/351

(57) ABSTRACT

The present invention discloses a detachable lampshade comprising an upper supporting hoop with a plurality of radial ribs, a lower supporting hoop with a plurality of locating pieces, and the translucent covering, and the upper and lower supporting hoops are secured to both ends of the translucent covering respectively, and there is a plurality of supporting mounts in between the upper and lower supporting hoops; the lower ends of the supporting mounts are fixed in between the locating pieces and the translucent covering; wherein there is an inner flange on the bottom surface and near the periphery of the upper supporting hoop, and the upper ends of the supporting mounts are fixed in between the inner flange and the translucent covering. The present invention provides a detachable lampshade which is of simpler construction and lower cost of manufacture and is easier to be disassembled and reassembled.

### BACKGROUND OF THE INVENTION

The present invention relates to lampshades and more particularly pertains to an improved detachable lampshade which is of simple construction and low cost of manufacture and is easily disassembled for storage and transport and reassembled for use.

Many attempts have been made in the past to provide detachable lampshades but when the shape is complicated, the construction becomes complicated, thereby increasing the production cost and making disassembly and reassembly difficult. Chinese Patent No. ZL02273058.3 discloses a detachable lampshade, which comprises an upper circular supporting hoop with a plurality of radial ribs, a lower circular supporting hoop with a plurality of locating pieces, and the translucent covering, wherein the upper and lower circular supporting hoops are secured to both ends of the translucent covering respectively. In between the upper and lower circular supporting hoops, there is a plurality of supporting mounts, each of which comprises a longitudinal supporting rib and a curved rod which is connected at right angles to the longitudinal supporting rib. At the other end of the longitudinal supporting rib, there is a notch which can fit securely to one of the radial ribs. The curved rod can be fixed in place securely by one of the locating pieces. This prior art is simple in structure, convenient to disassemble and re-assemble, easy to pack, compact in size for transportation, and aesthetic in appearance after assembled. However, this prior art has notches at the top ends of the longitudinal supporting ribs and the notches have to be fitted to the radial ribs so that the lampshade can be supported and form its shape. The number of the supporting mounts is equal to the number of the radial ribs. When the structure of a lampshade requires numerous supporting mounts to support the lampshade, the number of the radial ribs has to be increased correspondingly. In the circumstances, the structure of the lampshade becomes complex, and thereby increasing the production cost and making disassembly and re-assembly complicated.

### BRIEF SUMMARY OF THE INVENTION

In view of the aforesaid disadvantages now present in the prior art, the present invention provides a detachable lampshade which is of simpler construction and lower cost of manufacture and is easier to be disassembled and re-assembled.

To attain this, the detachable lampshade of the present invention generally comprises an upper supporting hoop with a plurality of radial ribs, a lower supporting hoop with a plurality of locating pieces, and the translucent covering; the upper and lower supporting hoops are secured to both ends of the translucent covering respectively, and there is a plurality of supporting mounts in between the upper and lower supporting hoops; the lower ends of the supporting mounts are fixed in between the locating pieces and the translucent covering; wherein there is a flange on the bottom surface and near the periphery of the upper supporting hoop, and the upper ends of the supporting mounts are fixed in between the flange and the translucent covering.

On the bottom surface and around the periphery of the upper supporting hoop, there is an additional flange, which constitutes the outer flange surrounding the inner flange with a groove formed in between. The outer flange and the inner flange may be continuous or intermittent in shape.

The supporting mounts comprise of a plurality of supporting ribs or supporting frames, and each of which has an upper supporting rod and a lower supporting rod at the two ends respectively. The upper supporting rods are fixed in between the inner flange and the translucent covering while the lower supporting rods are fixed in between the locating pieces and the translucent covering. The upper supporting rods may be straight or curved, and the lower supporting rods may also be straight or curved. The supporting frames may be in a standard or triangular tile shape or in a trapezoidal or triangular shape.

The upper or lower supporting hoop may be in a circular, oval, triangular or quadrilateral shape or in the shape of any other regular polygon.

By having the upper supporting hoop with the inner and outer flanges around its bottom periphery, the supporting mounts with the supporting rods at the two ends or with the supporting frames in a standard tile or trapezoidal shape or with the supporting frames in a triangular or triangular tile shape with the curved upper supporting rods, and that the upper ends of the supporting mounts are fixed in between the inner flange and the inner surface of the translucent covering or in between the inner flange and the outer flange, the present invention overcomes the problem of the prior art that when the structure of a lampshade requires numerous supporting mounts to support the lampshade, the number of the radial ribs has to be increased correspondingly.

It is an object of the present invention to provide a detachable lampshade which is easily disassembled for storage and transport and re-assembled for use.

It is another object of the present invention to provide a detachable lampshade which is of simple construction.

It is a further object of the present invention to provide a detachable lampshade which is susceptible of a low cost of manufacture with regard to both materials and labor, thereby making the detachable lampshade susceptible of low prices of sale and thus economically available to the buying public.

An even further object of the present invention is to provide a detachable lampshade which does not require an increased number of the radial ribs in the upper supporting hoop when the structure of the lampshade requires an increased number of supporting mounts for support, thus overcoming the disadvantages of the prior art.

### BRIEF DESCRIPTION OF THE DRAWINGS

FIG. 1 is a perspective diagram of the first embodiment of the present invention.

FIG. 2 is a bottom perspective view of FIG. 1.

FIG. 3 is a perspective view of a supporting mount according to the first embodiment.

FIG. 4 is a perspective view of the upper supporting hoop.

FIG. 5 is a perspective view of the upper supporting hoop according to another embodiment.

FIG. 6 is a perspective diagram of the second embodiment of the present invention.

FIG. 7 is a perspective diagram of the third embodiment of the present invention.

FIG. 8 is an exploded perspective view of the upper and lower supporting hoops shown in FIG. 7.

FIG. 9 is a perspective diagram of the fourth embodiment of the present invention.

FIG. 10 is a perspective diagram of the fifth embodiment of the present invention.

### DETAILED DESCRIPTION OF THE INVENTION

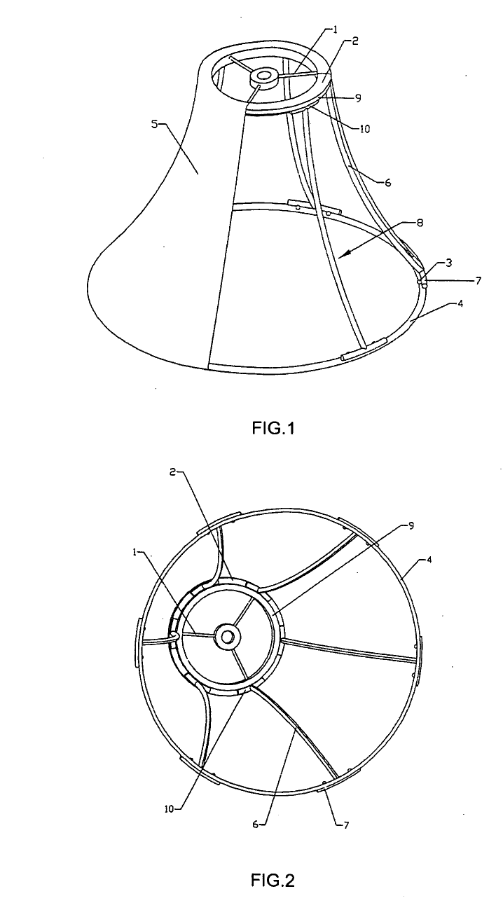

As illustrated in FIG. 1, the first embodiment of the present invention is a detachable lampshade which comprises an upper circular supporting hoop 2 with a plurality of radial ribs 1, a lower circular supporting hoop 4 with a plurality of locating pieces 3, and the translucent covering 5. In between the upper and lower circular supporting hoops 2, 4, there is a plurality of supporting mounts 8, each of which comprises a supporting rib 6 with an upper supporting rod 10 and a lower supporting rod 7 at its two ends respectively. On the bottom surface and near the periphery of the upper supporting hoop 2, there is an inner flange 9. The upper supporting rods 10 are fixed in between the inner flange 9 and the translucent covering 5. The lower supporting rods 7 are fixed in between the locating pieces 3 and the translucent covering 5. For the purposes of illustrating clearly the internal configuration of the lampshade, only a part of the translucent covering 5 is shown in FIG. 1.

FIG. 2 is a bottom perspective view of FIG. 1 and it shows more clearly the configuration of the parts of the first embodiment.

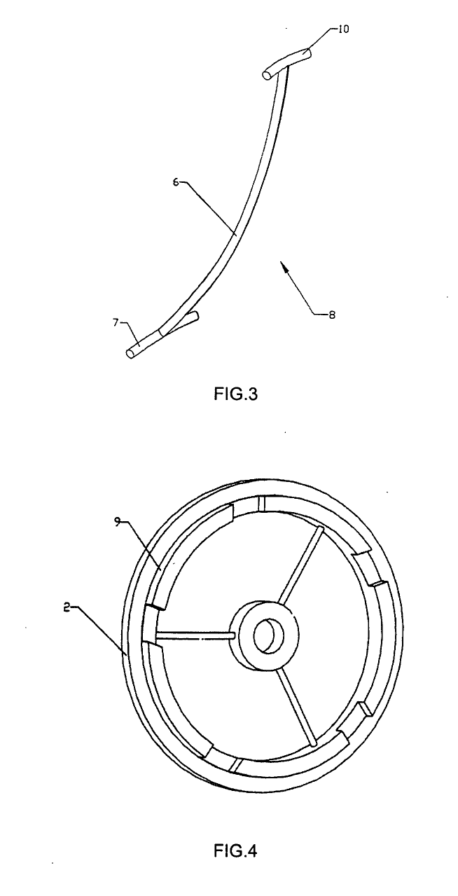

FIG. 3 is a perspective view of a supporting rib 6 and it shows clearly the upper supporting rod 10 and the lower supporting rod 7 at its two ends and the way they curve.

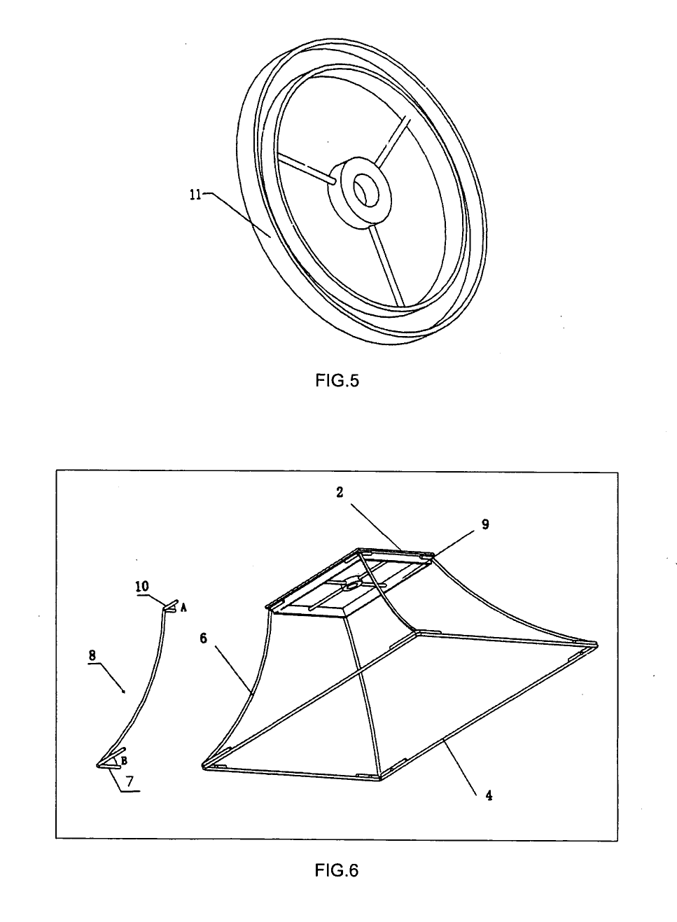

As illustrated in FIG. 4, the inner flange 9 on the bottom surface and near the periphery of the upper supporting hoop 2 is intermittent. FIG. 5 shows another embodiment of the upper supporting hoop 2, wherein the inner flange 9 is continuous. In addition, on the bottom surface and around the periphery of the upper supporting hoop 2, there is an additional flange 11, which constitutes the outer flange surrounding the inner flange 9 with a groove formed in between.

FIG. 6 shows the second embodiment of a detachable lampshade in a square shape. The angle A of the upper supporting rod 10 and the angle B of the lower supporting rod 7 of the supporting mount 8 are both right angles.

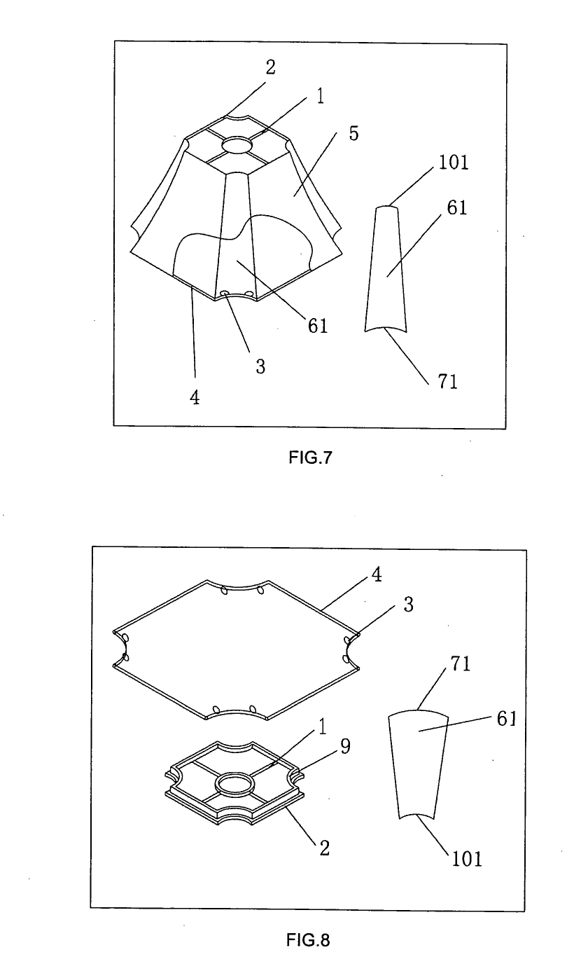

As illustrated in FIG. 7 and FIG. 8, the third embodiment of the present invention is a detachable lampshade in a square shape with arc-shaped angles. It comprises an upper supporting hoop 2 with a plurality of radial ribs 1, a lower supporting hoop 4 with a plurality of locating pieces 3, and the translucent covering 5. Both the upper supporting hoop 2 and the lower supporting hoop 4 are secured to both ends of the translucent covering respectively. In between the upper supporting hoop 2 and the lower supporting hoop 4, there are four tile-shaped supporting frames 61. The lower ends of the supporting frames 61 are fixed in between the locating pieces 3 and the translucent covering 5. On the bottom surface and near the periphery of the upper supporting hoop 2, there is an inner flange 9. The upper ends of the supporting frames 61 are fixed in between the outer surface of the inner flange 9 and the inner surface of the translucent covering 5. For the sake of illustrating clearly the internal configuration of the lampshade, FIG. 7 shows a part in sectional view. In FIG. 8, the upper supporting hoop 2 is shown underneath the lower supporting hoop 4 in order to illustrate clearly the configuration of the inner flange 9 in relation to the upper supporting hoop 2. When the lampshade is a square shape with arc-shaped angles, the upper and lower ends of the supporting frames 61 are all curved supporting rods 101, 71 and each of the supporting frames 61 as a whole is in a tile shape.

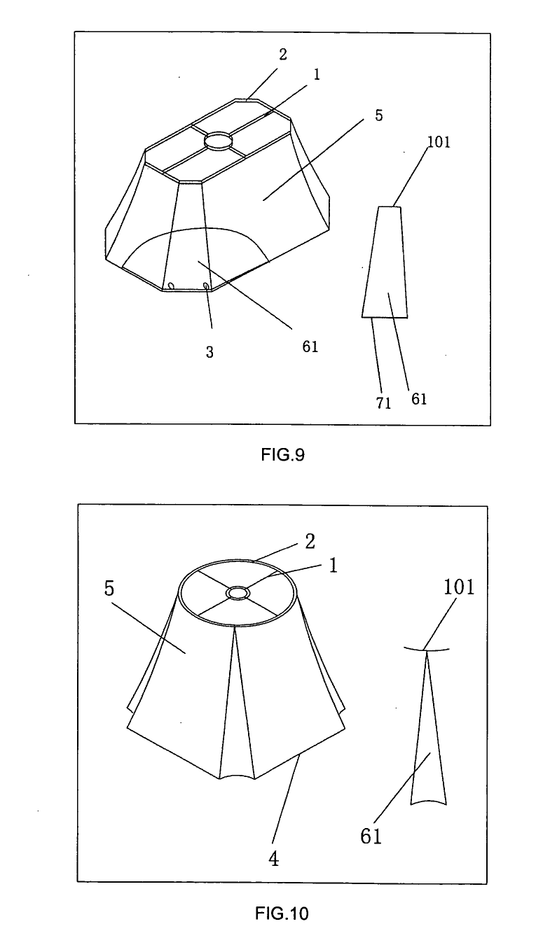

FIG. 9 illustrates the fourth embodiment of a detachable lampshade in a rectangular shape with truncated right angles. In this embodiment, the upper and lower ends of the supporting frames 61 are all straight supporting rods 101, 71 and each of the supporting frames 61 as a whole is in a trapezoidal shape.

FIG. 10 illustrates the fifth embodiment of a detachable lampshade with a circular upper supporting hoop 2 and the lower supporting hoop 4 in a square shape with arc-shaped angles. Each of the supporting frames 61 as a whole is in a triangular tile shape with a curved supporting rod 101 at its upper end.

The shape of the detachable lampshade of the present invention comprises the foregoing embodiments of different shapes of the lampshade, but the embodiments are meant to be illustrative only and not limiting. The foregoing embodiments are a few examples of typical lampshade shapes. Obviously, there are numerous combinations of the shapes of the upper and lower supporting hoops. For instance, the upper supporting hoop is in a square shape with truncated right angles and the lower supporting hoop is in a square shape with arc-shaped angles, or the two is identical or different in shape. To match with the shape of the upper and lower supporting hoops, the supporting rods of the supporting frames have to be in corresponding shape such as being straight or curved.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

The present invention is capable of other embodiments and of being practiced and carried out in various ways. It is to be understood that the phraseology and terminology employed herein are for the purpose of description and should not be regarded as limiting.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention.

1. A detachable lampshade comprising an upper supporting hoop with a plurality of radial ribs, a lower supporting hoop with a plurality of locating pieces, and the translucent covering, and the upper and lower supporting hoops are secured to both ends of the translucent covering respectively, and there is a plurality of supporting mounts in between the upper and lower supporting hoops; the lower ends of the supporting mounts are fixed in between the locating pieces and the translucent covering; wherein there is an inner flange on the bottom surface and near the periphery of the upper supporting hoop, and the upper ends of the supporting mounts are fixed in between the inner flange and the translucent covering.

2. A detachable lampshade as in claim 1, wherein said supporting mounts comprise a plurality of supporting ribs, and each of which has an upper supporting rod and a lower supporting rod at the two ends respectively; the upper supporting rods are fixed in between the inner flange and the translucent covering while the lower supporting rods are fixed in between the locating pieces and the translucent covering.

3. A detachable lampshade as in claim 1, wherein said supporting mounts comprise a plurality of supporting frames, and each of which has an upper supporting rod and a lower supporting rod at the two ends respectively; the upper supporting rods are fixed in between the inner flange and the translucent covering while the lower supporting rods are fixed in between the locating pieces and the translucent covering.

4. A detachable lampshade as in claim 1, wherein there is an outer flange on the bottom surface and around the periphery of the upper supporting hoop.

5. A detachable lampshade as in claim 1, wherein said inner flange is continuous or intermittent in shape.

6. A detachable lampshade as in claim 4, wherein said inner flange is continuous or intermittent in shape and said outer flange is continuous or intermittent in shape.

7. A detachable lampshade as in claim 2, wherein said upper supporting rods are straight or curved and said lower supporting rods are straight or curved.

8. A detachable lampshade as in claim 3, wherein said upper supporting rods are straight or curved and said lower supporting rods are straight or curved.

9. A detachable lampshade as in claim 3, wherein said supporting frames are each in a standard or triangular tile shape.

10. A detachable lampshade as in claim 3, wherein said supporting frames are each in a trapezoidal or triangular shape.

11. A detachable lampshade as in claim 1, wherein said upper and lower supporting hoops are each in a rectangle or square shape with truncated right angles.

12. A detachable lampshade as in claim 2, wherein said upper and lower supporting hoops are each in a rectangle or square shape with truncated right angles.

13. A detachable lampshade as in claim 3, wherein said upper and lower supporting hoops are each in a rectangle or square shape with truncated right angles.

14. A detachable lampshade as in claim 1, wherein said upper supporting hoop is in a circular shape and said lower supporting hoop is in a rectangle or square shape with truncated right angles.

15. A detachable lampshade as in claim 2, wherein said upper supporting hoop is in a circular shape and said lower supporting hoop is in a rectangle or square shape with truncated right angles.

16. A detachable lampshade as in claim 3, wherein said upper supporting hoop is in a circular shape and said lower supporting hoop is in a rectangle or square shape with truncated right angles.

17. A detachable lampshade as in claim 14, wherein said supporting frame is in a triangular tile shape with a curved supporting rod at its upper end.

18. A detachable lampshade as in claim 15, wherein said supporting frame is in a triangular tile shape with a curved supporting rod at its upper end.

19. A detachable lampshade as in claim 16, wherein said supporting frame is in a triangular tile shape with a curved supporting rod at its upper end.

20. A detachable lampshade as in claim 1, wherein said upper or lower supporting hoop is in a circular, oval, triangular or quadrilateral shape or in the shape of any other regular polygon.
